(19) United States
(12) Patent Application Publication
(10) Pub. No.: US 2025/0367778 A1
(43) Pub. Date: Dec. 4, 2025

(54) HANDHELD POWER TOOL AND POLISHER

(71) Applicant: Nanjing Chervon Industry Co., Ltd., Nanjing (CN)

(72) Inventors: Xiang Zhang, Nanjing (CN); Yonghui Cheng, Nanjing (CN); Shubin Tong, Nanjing (CN)

(21) Appl. No.: 19/305,969

(22) Filed: Aug. 21, 2025

Related U.S. Application Data
(63) Continuation of application No. PCT/CN2024/084074, filed on Mar. 27, 2024.

(30) Foreign Application Priority Data
Apr. 14, 2023 (CN) 202310407726.6

(51) Int. Cl. B24B 23/02; B24B 47/12; B25F 5/00

(52) U.S. Cl. CPC B24B 23/02; B24B 47/12; B25F 5/001

(57) ABSTRACT

A handheld power tool includes a housing, an electric motor, an output shaft, and a transmission assembly, where the electric motor is disposed in the housing, the output shaft is rotatably disposed on the housing, the transmission assembly includes a planet gear assembly, an input end of the planet gear assembly is connected to a motor shaft, and an output end of the planet gear assembly is connected to the output shaft. The handheld power tool has at least three operating modes; during operation in a first operating mode, the rotational speed of the output shaft is less than or equal to 1500 RPM; during operation in a second operating mode, the rotational speed of the output shaft is greater than 1500 RPM and less than 5000 RPM; and during operation in a third operating mode, the rotational speed of the output shaft is greater than or equal to 5000 RPM.

### RELATED APPLICATION INFORMATION

This application is a continuation of International Application Number PCT/CN2024/084074, filed on Mar. 27, 2024, through which this application also claims the benefit under 35 U.S.C. § 119(a) of Chinese Patent Application No. CN 202310407726.6, filed on Apr. 14, 2023, which applications are incorporated herein by reference in their entireties.

### BACKGROUND

A polisher, also referred to as a grinder, is commonly used in processes such as mechanical grinding, polishing, and waxing.

Currently, the polisher on the market has only two functions: a high speed (sanding) and a low speed (polishing). However, there is a large demand for cleaning accessories on the market, and the polisher with the two functions cannot satisfy a requirement for a rotational speed at which the polisher cleans accessories.

Therefore, it is urgent to study a handheld power tool that integrates sanding (for example, metal, wood, and automotive paints), polishing (for example, automotive paints), and cleaning (for example, automobile hubs), so as to satisfy user requirements for more working conditions.

### SUMMARY

The present application adopts the technical solutions below.

In one aspect, the present application provides a handheld power tool. The handheld power tool includes a housing; an electric motor disposed in the housing; an output shaft rotatably disposed on the housing; and a transmission assembly including a planet gear assembly, where an input end of the planet gear assembly is connected to a motor shaft, and an output end of the planet gear assembly is connected to the output shaft. The handheld power tool has at least three operating modes; during operation in a first operating mode, the rotational speed of the output shaft is less than or equal to 1500 RPM; during operation in a second operating mode, the rotational speed of the output shaft is greater than 1500 RPM and less than 5000 RPM; during operation in a third operating mode, the rotational speed of the output shaft is greater than or equal to 5000 RPM.

As an optional technical solution of the handheld power tool, the handheld power tool includes a battery coupling portion for mounting a battery pack.

As an optional technical solution of the handheld power tool, the handheld power tool is capable of standing on a placement plane P through a bottom surface of the battery pack, the angle between an axis A of the output shaft and the placement plane P is a first angle α, and the first angle α is greater than or equal to 0° and less than or equal to 20°.

As an optional technical solution of the handheld power tool, the housing includes a grip, the grip is disposed between the electric motor and the battery coupling portion, the angle between an extension direction of the grip and the axis A of the output shaft is a second angle β, and the second angle β is greater than or equal to 50° and less than or equal to 90°.

As an optional technical solution of the handheld power tool, the planet gear assembly includes only one stage of planetary gearset, and a gear ratio of the planet gear assembly is greater than 1 and less than 5.

As an optional technical solution of the handheld power tool, the planet gear assembly includes only two stages of planetary gearsets, and a gear ratio of the planet gear assembly is greater than 1 and less than 15.

As an optional technical solution of the handheld power tool, the handheld power tool includes a mode switching device configured to switch a gear of the handheld power tool by transmitting an electrical signal.

As an optional technical solution of the handheld power tool, the planet gear assembly includes at least one inner ring gear, the mode switching device includes a speed regulation toggle for adjusting the inner ring gear to move between a first speed position and a second speed position, the handheld power tool is in the second operating mode when the inner ring gear is at the first speed position, and the handheld power tool is in the third operating mode when the inner ring gear is at the second speed position.

As an optional technical solution of the handheld power tool, the handheld power tool includes a mode switching device including at least one operating button for adjusting the rotational speed of the electric motor so that the handheld power tool switches between the first operating mode, the second operating mode, and the third operating mode.

As an optional technical solution of the handheld power tool, the mode switching device includes a Hall sensor disposed in the housing.

As an optional technical solution of the handheld power tool, the handheld power tool operating in the first operating mode is usable with a cleaning brush; the handheld power tool operating in the second operating mode is usable with a polishing disc; and the handheld power tool operating in the third operating mode is usable with a sanding disc.

In another aspect, the present application provides a polisher. The polisher includes a housing; an electric motor disposed in the housing; an output shaft rotatably disposed on the housing; and a transmission assembly including a planet gear assembly, where an input end of the planet gear assembly is connected to a motor shaft, and an output end of the planet gear assembly is connected to the output shaft. The polisher has at least three operating modes, and the three operating modes are a cleaning mode, a polishing mode, and a sanding mode, respectively; when the polisher is in the cleaning mode, the rotational speed of the output shaft is less than or equal to a first rotational speed; when the polisher is in the sanding mode, the rotational speed of the output shaft is greater than or equal to a second rotational speed; when the polisher is in the polishing mode, the rotational speed of the output shaft is greater than the first rotational speed and less than the second rotational speed.

As an optional technical solution of the handheld power tool, the polisher further includes a mode switching device configured to be operated by a user to drive the polisher to switch between at least the cleaning mode, the polishing mode, and the sanding mode.

As an optional technical solution of the handheld power tool, the polisher includes a battery coupling portion for mounting a battery pack, the polisher is capable of standing on a placement plane P through a bottom surface of the battery pack, the angle between an axis A of the output shaft and the placement plane P is a first angle α, and the first angle α is greater than or equal to 0° and less than or equal to 20°.

As an optional technical solution of the handheld power tool, the housing includes a grip, the grip is disposed between the electric motor and the battery coupling portion, the angle between an extension direction of the grip and the axis A of the output shaft is a second angle β, and the second angle β is greater than or equal to 50° and less than or equal to 90°.

As an optional technical solution of the handheld power tool, the planet gear assembly includes only one stage of planetary gearset, and a gear ratio of the planet gear assembly is greater than 1 and less than 5.

As an optional technical solution of the handheld power tool, the planet gear assembly includes only two stages of planetary gearsets, and a gear ratio of the planet gear assembly is greater than 1 and less than 15.

As an optional technical solution of the handheld power tool, the mode switching device switches a gear of the polisher by transmitting an electrical signal.

As an optional technical solution of the handheld power tool, the mode switching device includes a Hall sensor disposed in the housing.

As an optional technical solution of the handheld power tool, the planet gear assembly includes at least one inner ring gear, the mode switching device includes a speed regulation toggle for adjusting the inner ring gear to move between a first speed position and a second speed position, the polisher is in the sanding mode when the inner ring gear is at the first speed position, and the polisher is in the polishing mode when the inner ring gear is at the second speed position.

As an optional technical solution of the handheld power tool, the polisher includes a mode switching device including at least one operating button for adjusting the rotational speed of the electric motor so that the polisher switches between the cleaning mode, the polishing mode, and the sanding mode.

### BRIEF DESCRIPTION OF DRAWINGS

FIG. 1 is a structural view of a handheld power tool from a first angle according to an example of the present application;

FIG. 2 is a sectional view of a handheld power tool according to an example of the present application;

FIG. 3 is an internal structural view of a handheld power tool according to an example of the present application;

FIG. 4 is a structural view of an electric motor and a transmission assembly according to an example of the present application;

FIG. 5 is a partial exploded view of a transmission assembly according to an example of the present application;

FIG. 6 is a structural view of a speed regulation toggle from a first angle according to an example of the present application;

FIG. 7 is a structural view of a speed regulation toggle from a second angle according to an example of the present application;

FIG. 8 is a structural view of a handheld power tool from a second angle according to an example of the present application;

FIG. 9 is a schematic view of a handheld power tool from a third angle according to an example of the present application;

FIG. 10 is a structural view of a handheld power tool including a speed button according to an example of the present application;

FIG. 11 is a sectional view of a handheld power tool including a speed button according to an example of the present application;

FIG. 12 is a structural view of a speed button and a mode button according to an example of the present application;

FIG. 13 is a structural view of a handheld power tool with a sanding disc according to an example of the present application;

FIG. 14 is a structural view of a handheld power tool with a polishing disc according to an example of the present application; and

FIG. 15 is a structural view of a handheld power tool with a cleaning brush according to an example of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

The present application provides a handheld power tool. In some examples, the power tool may be a polisher, a sander, or an angle grinder. Of course, in other examples, a work attachment may be replaced as required so that the power tool becomes a tool capable of performing another task, such as an impact drill or an electric screwdriver.

Examples of the present application are described in detail below. The examples are illustrated in the drawings, where the same or similar reference numerals throughout the drawings represent the same or similar elements or elements having the same or similar functions. The examples described below with reference to the drawings are illustrative, are used only for explaining the present application, and are not to be construed as limiting the present application.

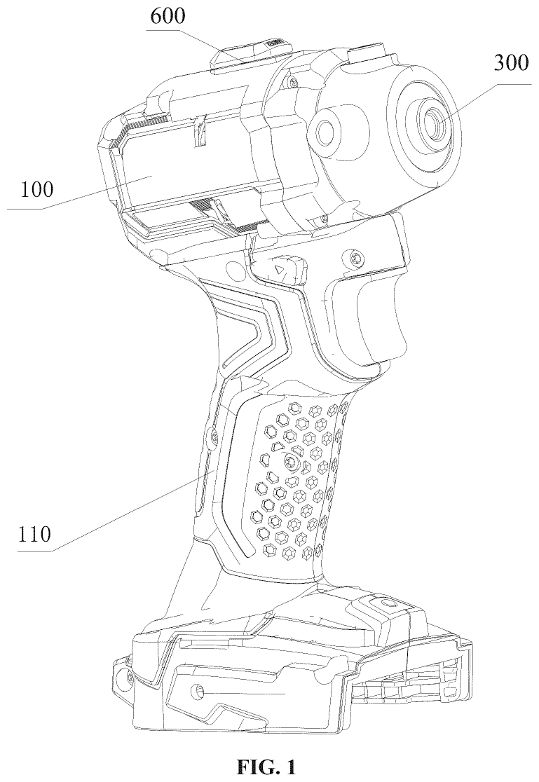

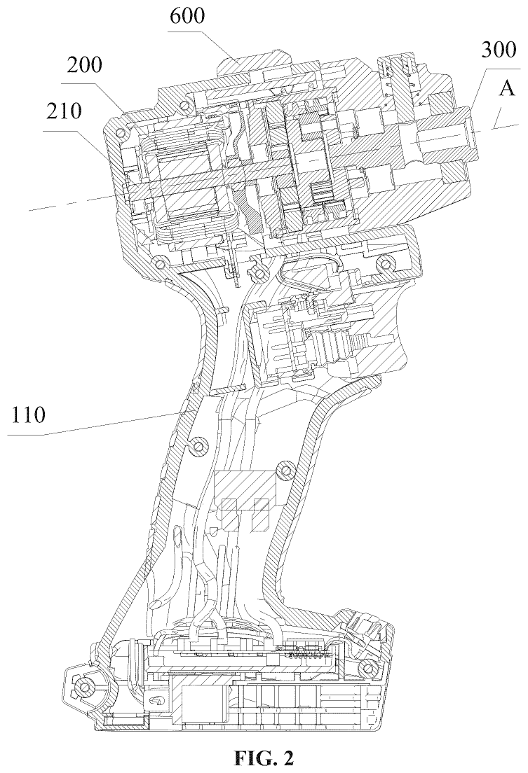

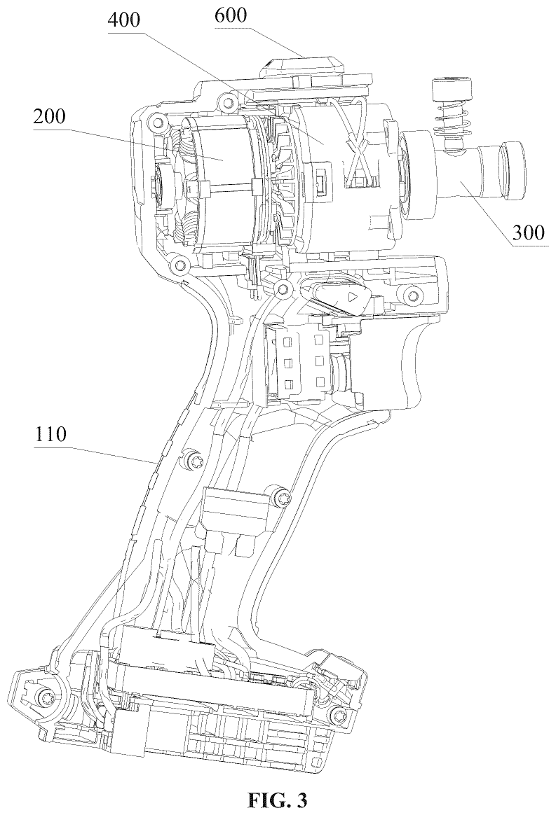

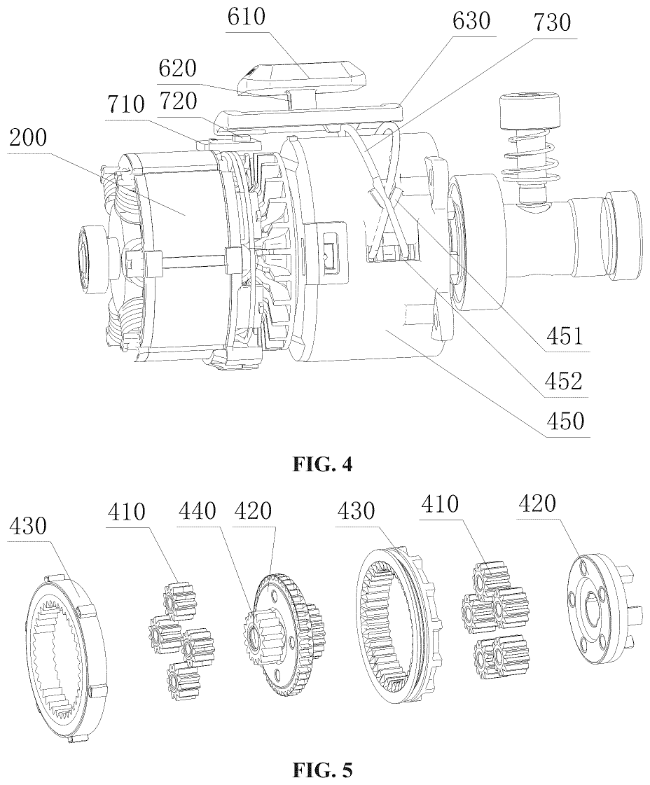

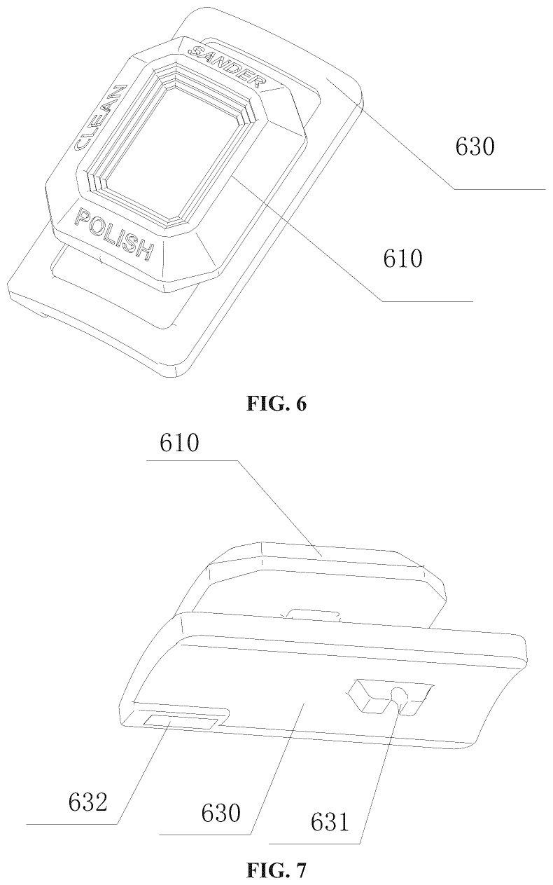

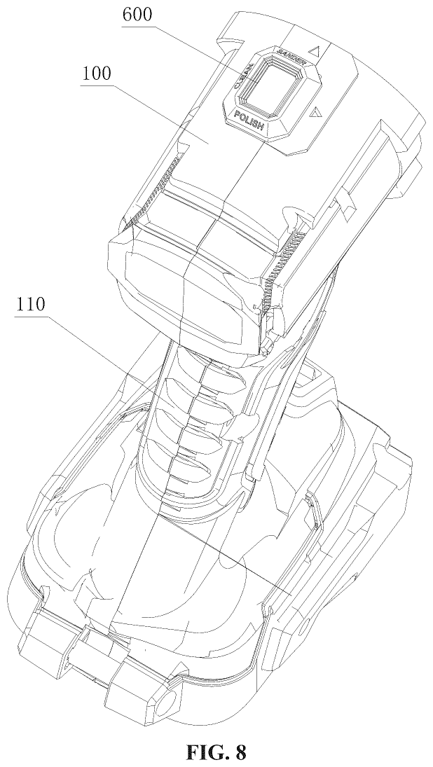

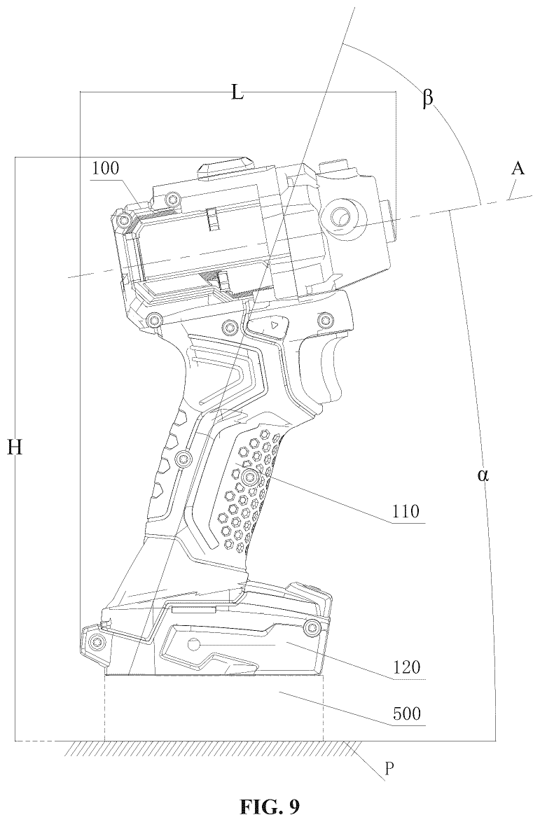

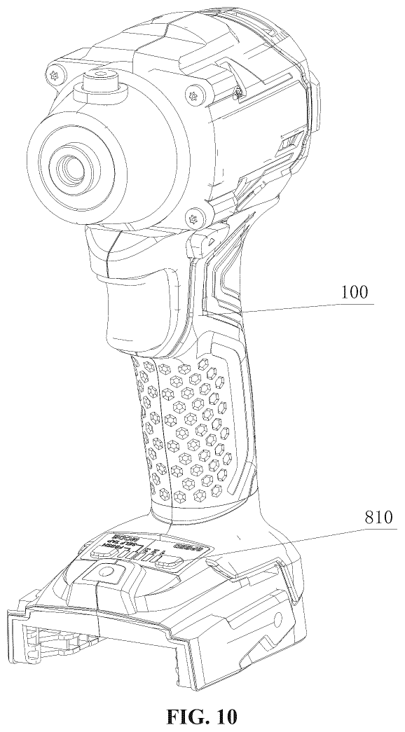

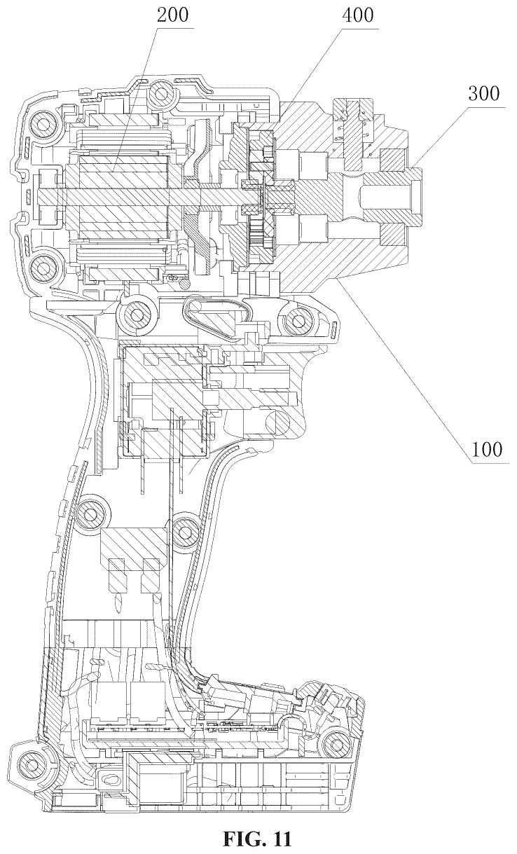

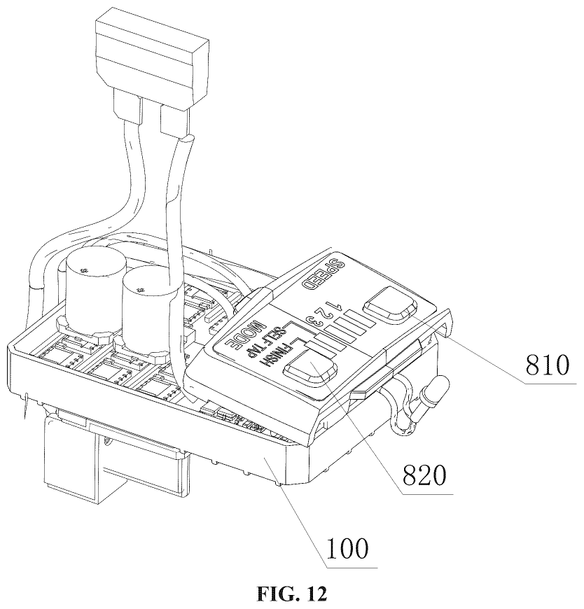

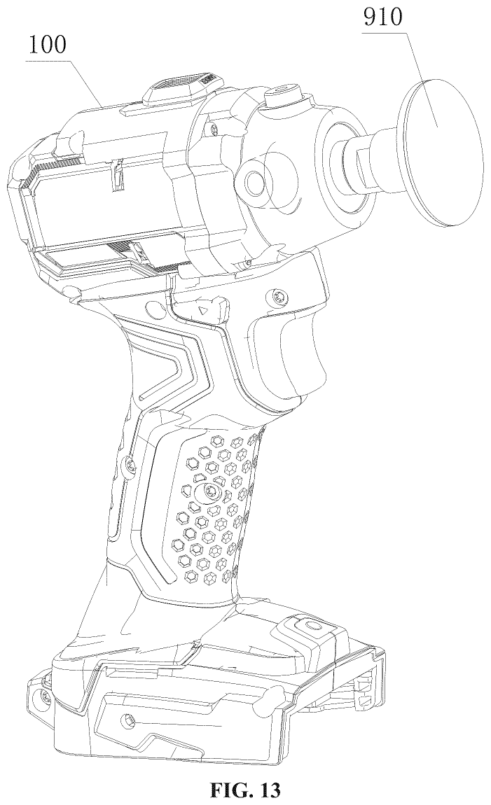

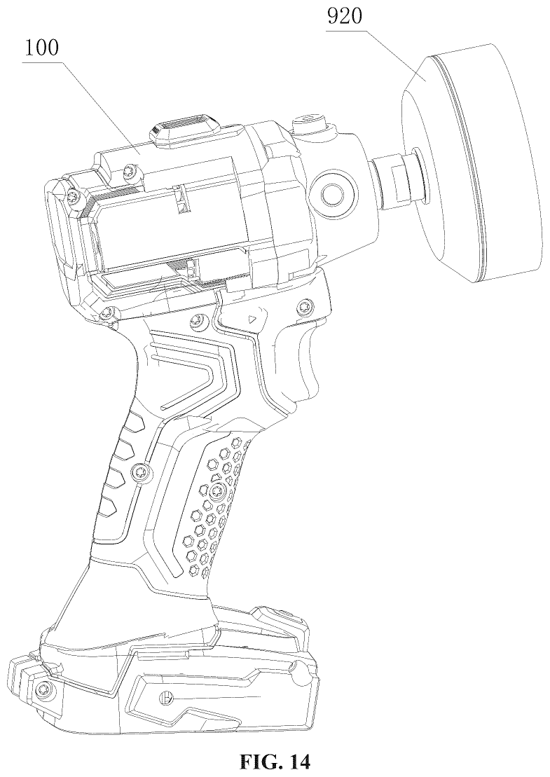

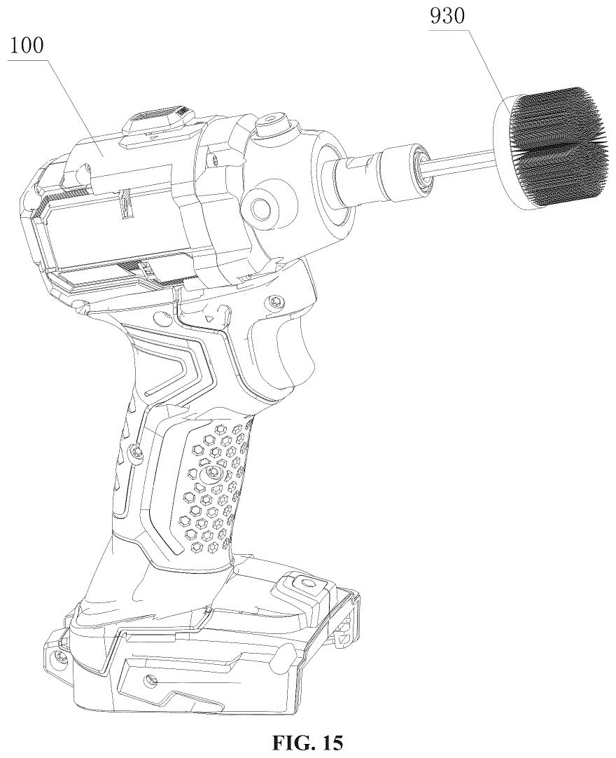

As shown in FIGS. 1 to 15, this example provides a handheld power tool including a housing 100, an electric motor 200, an output shaft 300, and a transmission assembly 400. The electric motor 200 is disposed in the housing 100. At least part of the output shaft 300 is disposed in the housing 100, and the output shaft 300 is rotatable. The transmission assembly 400 includes a planet gear assembly, an input end of the planet gear assembly is connected to a motor shaft 210, and an output end of the planet gear assembly is connected to the output shaft 300. The handheld power tool has at least three operating modes. During operation in a first operating mode, the rotational speed of the output shaft 300 is less than or equal to 1500 RPM, and the output shaft 300 with such a rotational speed can mate with a cleaning brush 930 to satisfy a requirement of a user for cleaning (automobile hubs and the like). During operation in a second operating mode, the rotational speed of the output shaft 300 is greater than 1500 RPM and less than 5000 RPM, and the output shaft 300 with such a rotational speed can mate with a polishing disc 920 to satisfy a requirement of the user for polishing (automobile paints and the like). During operation in a third operating mode, the rotational speed of the output shaft 300 is greater than or equal to 5000 RPM, and the output shaft 300 with such a rotational speed can mate with a sanding disc 910 to satisfy a requirement of the user for sanding (metal, wood, automobile paints, and the like). Thus, the handheld power tool can satisfy user requirements for more working conditions.

In an example, during operation in the third operating mode, the rotational speed of the output shaft 300 is greater than or equal to 6000 RPM. In an example, during operation in the third operating mode, the rotational speed of the output shaft 300 is greater than or equal to 7000 RPM. In an example, during operation in the third operation mode, the rotational speed of the output shaft 300 is greater than or equal to 8000 RPM. In a specific example, during operation in the third operating mode, the rotational speed of the output shaft 300 is about 9000 RPM, and the handheld power tool has relatively good polishing performance.

The handheld power tool includes a battery coupling portion 120 for mounting a battery pack 500. In this example, the battery pack 500 may be electrically connected to the electric motor 200 to satisfy a requirement for power supply to the electric motor 200 so that the handheld power tool can be moved more conveniently. In other examples, the electric motor 200 may be connected to an external power supply via a cable.

In this example, the battery pack 500 is a rectangular battery, and a bottom surface of the battery pack 500 is planar and can conveniently serve as a base for placing the handheld power tool. The handheld power tool has an overall height H and a width L. The handheld power tool is capable of standing on a placement plane P through the bottom surface of the battery pack 500, the angle between an axis A of the output shaft 300 and the placement plane P is a first angle α, and the first angle α is greater than or equal to 0° and less than or equal to 20°. Of course, in other examples, the first angle α may be greater than 20°.

To improve the grip comfort of the handheld power tool and facilitate operation, in this example, the housing 100 includes a grip 110, the grip 110 is disposed between the electric motor 200 and the battery coupling portion 120, the angle between an extension direction of the grip 110 and the axis A of the output shaft 300 is a second angle β, and the second angle β is greater than or equal to 50° and less than or equal to 90°. Thus, when the grip 110 is in a vertical state, the axis A of the output shaft 300 is inclined upward, and the output shaft 300 is inclined upward. The electric motor 200 and the output shaft 300 are disposed coaxially. In other examples, a value of the second angle β may be set according to a specific working condition. Specifically, the second angle β may be less than 50° or greater than 90°.

As for speed regulation, in this example, the handheld power tool includes a mode switching device configured to switch a gear of the handheld power tool by transmitting an electrical signal. The electrical signal may be specifically transmitted through photoelectric coding, a piezoelectric sensor, a position sensor, or the like.

In an example, the mode switching device includes a Hall sensor 710 disposed in the housing 100. When sensing a change in a magnetic field, the Hall sensor 710 sends the electrical signal, and the handheld power tool switches to the first operating mode. The Hall sensor 710 facilitates the triggering of signals. In this example, when sensing the change in the magnetic field, the Hall sensor 710 sends the electrical signal, and the handheld power tool switches from the second operating mode to the first operating mode. Of course, in other examples, when sensing the change in the magnetic field, the Hall sensor 710 sends the electrical signal, and the handheld power tool may directly switch from the third operating mode to the first operating mode.

Specifically, the mode switching device includes a speed regulation toggle 600 disposed on the housing 100, and the mode switching device includes a magnet 720 disposed in the speed regulation toggle 600. The speed regulation toggle 600 is movable between a first speed regulation position and a second speed regulation position. The Hall sensor 710 senses the change in the magnetic field when the speed regulation toggle 600 is at the first speed regulation position. When the speed regulation toggle 600 is at the second speed regulation position, the Hall sensor 710 loses a magnetic field signal. When the speed regulation toggle 600 is at the first speed regulation position, the handheld power tool switches from the second operating mode to the first operating mode. When the speed regulation toggle 600 is at the second speed regulation position, the handheld power tool switches from the first operating mode to the second operating mode. In other examples, the magnet 720 may be disposed separately from the handheld power tool.

It is to be noted that when sensing the change in the magnetic field, the Hall sensor 710 sends the electrical signal, and a controller controls a duty cycle of the electric motor 200 according to the signal and switches the gear of the handheld power tool to the first operating mode.

Specifically, the planet gear assembly includes at least one inner ring gear 430, the mode switching device includes the speed regulation toggle 600 for adjusting the inner ring gear 430 to move between a first speed position and a second speed position, the handheld power tool is in the second operating mode when the inner ring gear 430 is at the first speed position, and the handheld power tool is in the third operating mode when the inner ring gear 430 is at the second speed position.

As for the structure of the planet gear assembly, in this example, the planet gear assembly includes multiple stages of planetary gearsets. Each stage of planetary gearset includes at least one planet gear 410, a planet carrier 420 for mounting the planet gear 410, and the inner ring gear 430 engaged with the planet gear 410. A sun gear 440 is formed on or connected to the motor shaft 210 and configured to input power of the electric motor 200 to the planet gear assembly.

According to different specific requirements for a gear ratio, one or more stages of planetary gearsets may be provided, which does not affect the substantial content of the present application. In this example, the planet gear assembly includes only one stage of planetary gearset, which may be defined as a first planetary gearset. In this example, the one stage of planetary gearset is configured with one transmission state, that is to say, the transmission assembly 400 provides one gear ratio. The gear ratio of the transmission assembly 400 is greater than 1 and less than 5. In some examples, the gear ratio of the transmission assembly 400 is greater than or equal to 10. In some examples, the gear ratio of the transmission assembly 400 is greater than or equal to 20. In some examples, the gear ratio of the transmission assembly 400 is greater than or equal to 30. In some examples, the gear ratio of the transmission assembly 400 is greater than or equal to 40. Thus, the output shaft 300 has multiple output speeds. In this example, the transmission assembly 400 may be an acceleration structure. In other examples, the transmission assembly 400 may be a reduction structure.

In this example, the planet gear assembly includes only two stages of planetary gearsets, which may be defined as a first planetary gearset and a second planetary gearset, and the gear ratio of the planet gear assembly is greater than 1 and less than 15. In other examples, the planet gear assembly may include three or even four stages of planetary gearsets to achieve a higher gear ratio.

The working principles of speed regulation through planet gears and mechanical adjustment of the gear ratio and the acceleration or reduction performed by such a transmission mechanism have been fully disclosed to those skilled in the art. Therefore, a detailed description is omitted here for clarity of description.

As for an adjustment manner of the inner ring gear 430, in this example, a swing frame 730 is toggled via the speed regulation toggle 600. The whole swing frame 730 is C-shaped and includes a connection portion, a hinge portion, and a toggle portion. The connection portion is located at a middle position of the swing frame 730, two toggle portions are provided and located at two ends of the swing frame 730 one to one, two hinge portions are provided, one hinge portion is disposed between the connection portion and one toggle portion, and the other hinge portion is disposed between the connection portion and the other toggle portion. The hinge portions are hinged to a planetary housing 450 of the planet gear assembly, the connection portion is connected to the speed regulation toggle 600, and the toggle portions are connected to the inner ring gear 430. When the speed regulation toggle 600 is at the second speed regulation position, the inner ring gear 430 is toggled by the toggle portions to the first speed position. When the speed regulation toggle 600 is at a third speed regulation position, the inner ring gear 430 is toggled by the toggle portions to the second speed position. Specifically, U-shaped brackets 451 are provided on two sides of the planetary housing 450, the swing frame 730 is formed by bending a steel wire, and the hinge portion of the swing frame 730 is Z-shaped. Toggle slots 452 are provided on the two sides of the planetary housing 450, and the toggle portions are connected to the inner ring gear 430 through the toggle slots 452. An annular groove is provided on an outer circumference of the inner ring gear 430, and the toggle portions are located in the annular groove.

The planetary housing 450 is disposed in the housing 100, and the planet gear 410, the sun gear 440, the inner ring gear, and the like in the planet gear assembly are located in the planetary housing 450.

The speed regulation toggle 600 is moved along a direction of the axis A of the output shaft 300 to be movable between the second speed regulation position and the third speed regulation position, and the speed regulation toggle 600 at the second speed regulation position can be rotated along a circumferential direction of the electric motor 200 to move between the first speed regulation position and the second speed regulation position during movement.

In this example, the speed regulation toggle 600 is provided with an operating portion 610, an intermediate portion 620, and an actuation portion 630, where one end of the intermediate portion 620 is connected to the operating portion 610, the other end of the intermediate portion 620 is connected to the actuation portion 630, the housing 100 is provided with an adjustment slot, the operating portion 610 is located outside the housing 100, the intermediate portion 620 is located in the adjustment slot, and the actuation portion 630 is located inside the housing 100.

Further, the adjustment slot includes a first slot and a second slot communicating with each other, an extension direction of the first slot is perpendicular to an extension direction of the second slot, the first slot is disposed along the circumferential direction of the electric motor 200, and the second slot is disposed along the axis A of the output shaft 300. In a process of sliding in the first slot, the speed regulation toggle 600 can move between the first speed regulation position and the second speed regulation position. In a process of sliding in the second slot, the speed regulation toggle 600 can move between the second speed regulation position and the third speed regulation position. Specifically, the actuation portion 630 is provided with a clamping slot 631, and an extension direction of the clamping slot 631 is perpendicular to the direction of the axis A of the output shaft 300. Thus, in the process of sliding in the second slot, the speed regulation toggle 600 can drive the swing frame 730 to swing about the U-shaped brackets 451. When the speed regulation toggle 600 slides in the first slot, the connection portion of the swing frame 730 slides in the clamping slot 631 along the extension direction of the clamping slot 631, that is, when the speed regulation toggle 600 moves between the first speed regulation position and the second speed regulation position, the swing frame 730 remains stationary.

The actuation portion 630 is provided with a mounting recess 632, and the magnet 720 is located in the mounting recess 632. Further, the magnet 720 is bonded in the mounting recess 632.

As for the gear adjustment of the handheld power tool, in an implementation of this example, the mode switching device includes at least one operating button for adjusting the rotational speed of the electric motor 200 so that the handheld power tool switches between the first operating mode, the second operating mode, and the third operating mode. Specifically, two operating buttons are provided, which may be specifically labeled as a speed-up button and a speed-down button. The speed-up button controls an increment in the gear, and the speed-down button controls a decrement in the gear. The number of presses on the speed-up button is positively correlated to the duty cycle of the electric motor 200, and the number of presses on the speed-down button is negatively correlated to the duty cycle of the electric motor 200. That is, each time the speed-up button is pressed, the duty cycle of the electric motor 200 is increased by a preset value and accordingly, the rotational speed of the electric motor 200 is increased and the gear of the handheld power tool is increased; each time the speed-down button is pressed, the duty cycle of the electric motor 200 is decreased by the preset value and accordingly, the rotational speed of the electric motor 200 is decreased and the gear of the handheld power tool is decreased.

In another implementation of this example, the mode switching device includes one operating button for adjusting the rotational speed of the electric motor 200 so that the handheld power tool switches between the first operating mode, the second operating mode, and the third operating mode cyclically.

In another implementation of this example, the mode switching device includes two operating buttons, which are a speed button 810 and a mode button 820, respectively. The speed button 810 is configured to adjust the rotational speed of the electric motor 200 so that the handheld power tool switches between the first operating mode, the second operating mode, and the third operating mode cyclically. Specifically, the speed button 810 adjusts the rotational speed of the electric motor 200 by adjusting the duty cycle of the electric motor 200. The mode button 820 is configured to control a head change mode and an end mode, the handheld power tool can be fitted with a different work head in the head change mode when the speed button 810 cannot adjust the speed, and the end mode indicates that a work head has been changed and the speed button 810 can adjust the speed. Accordingly, the mode switching device includes five indicator lights corresponding to the first operating mode, the second operating mode, the third operating mode, the head change mode, and the end mode, respectively.

In this example, the work head may include the sanding disc 910, the polishing disc 920, the cleaning brush 930, or another attachment.

Additionally, the present application further provides a polisher including a housing 100, an electric motor 200, an output shaft 300, and a transmission assembly 400. The electric motor 200 is disposed in the housing 100. The output shaft 300 is rotatably disposed on the housing 100. The transmission assembly 400 includes a planet gear assembly, an input end of the planet gear assembly is connected to a motor shaft 210, and an output end of the planet gear assembly is connected to the output shaft 300. The polisher has at least three operating modes, and the three operating modes are a cleaning mode, a polishing mode, and a sanding mode, respectively; when the polisher is in the cleaning mode, the rotational speed of the output shaft 300 is less than or equal to a first rotational speed; when the polisher is in the sanding mode, the rotational speed of the output shaft 300 is greater than or equal to a second rotational speed; when the polisher is in the polishing mode, the rotational speed of the output shaft 300 is greater than the first rotational speed and less than the second rotational speed. The polisher further includes a mode switching device configured to be operated by a user to drive the polisher to switch between at least the cleaning mode, the polishing mode, and the sanding mode.

In an example, the first rotational speed is greater than or equal to 1000 RPM and less than or equal to 2000 RPM. In an example, the second rotational speed is greater than or equal to 5000 RPM. In an example, the second rotational speed is greater than or equal to 6000 RPM. In an example, the second rotational speed is greater than or equal to 7000 RPM. In an example, the second rotational speed is greater than or equal to 8000 RPM.

In an example, the polisher further includes the mode switching device configured to be operated by the user to drive the polisher to switch between at least the cleaning mode, the polishing mode, and the sanding mode. The mode switching device switches a gear of the polisher by transmitting an electrical signal. In an example, the polisher includes the mode switching device including at least one operating button for adjusting the rotational speed of the electric motor so that the polisher switches between the cleaning mode, the polishing mode, and the sanding mode. In an example, the mode switching device includes a Hall sensor disposed in the housing. A specific setting of the mode switching device is consistent with that described above in the present application, which is not repeated here.

In an example, the polisher includes a battery coupling portion for mounting a battery pack, the polisher is capable of standing on a placement plane P through a bottom surface of the battery pack, the angle between an axis A of the output shaft and the placement plane P is a first angle α, and the first angle α is greater than or equal to 0° and less than or equal to 20°. The housing includes a grip, the grip is disposed between the electric motor and the battery coupling portion, the angle between an extension direction of the grip and the axis A of the output shaft is a second angle β, and the second angle β is greater than or equal to 50° and less than or equal to 90°.

In an example, the planet gear assembly includes only one stage of planetary gearset, and a gear ratio of the planet gear assembly is greater than 1 and less than 5. In an example, the planet gear assembly includes only two stages of planetary gearsets, and the gear ratio of the planet gear assembly is greater than 1 and less than 15. In an example, the planet gear assembly includes at least one inner ring gear, the mode switching device includes a speed regulation toggle for adjusting the inner ring gear to move between a first speed position and a second speed position, the polisher is in the sanding mode when the inner ring gear is at the first speed position, and the polisher is in the polishing mode when the inner ring gear is at the second speed position.

It is to be noted that the technical solutions in the examples described above can be combined with each other, and some repetitive features are not repeatedly described in the present application.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A handheld power tool, comprising:
a housing;
an electric motor comprising a motor shaft and disposed in the housing;
an output shaft rotatably disposed on the housing; and
a transmission assembly comprising a planet gear assembly, an input end of the planet gear assembly is connected to the motor shaft, and an output end of the planet gear assembly is connected to the output shaft;
wherein the handheld power tool has at least three operating modes; when the handheld power tool operates in a first operating mode, a rotational speed of the output shaft is less than or equal to 1500 RPM; when the handheld power tool operates in a second operating mode, the rotational speed of the output shaft is greater than 1500 RPM and less than 5000 RPM; when the handheld power tool operates in a third operating mode, the rotational speed of the output shaft is greater than or equal to 5000 RPM.

2. The handheld power tool according to claim 1, further comprising a battery coupling portion for mounting a battery pack.

3. The handheld power tool according to claim 2, wherein the handheld power tool is capable of standing on a placement plane P through a bottom surface of the battery pack, an angle between an axis A of the output shaft and the placement plane P is a first angle α, and the first angle α is greater than or equal to 0° and less than or equal to 20°.

4. The handheld power tool according to claim 3, wherein the housing comprises a grip, the grip is disposed between the electric motor and the battery coupling portion, an angle between an extension direction of the grip and the axis A of the output shaft is a second angle β, and the second angle β is greater than or equal to 50° and less than or equal to 90°.

5. The handheld power tool according to claim 1, wherein the planet gear assembly comprises only one stage of planetary gearset, and a gear ratio of the planet gear assembly is greater than 1 and less than 5.

6. The handheld power tool according to claim 1, wherein the planet gear assembly comprises only two stages of planetary gearsets, and a gear ratio of the planet gear assembly is greater than 1 and less than 15.

7. The handheld power tool according to claim 1, further comprising a mode switching device configured to switch a gear of the handheld power tool by transmitting an electrical signal.

8. The handheld power tool according to claim 7, wherein the planet gear assembly comprises at least one inner ring gear, the mode switching device comprises a speed regulation toggle for adjusting the inner ring gear to move between a first speed position and a second speed position, the handheld power tool is in the second operating mode when the inner ring gear is at the first speed position, and the handheld power tool is in the third operating mode when the inner ring gear is at the second speed position.

9. The handheld power tool according to claim 1, further comprising a mode switching device comprising at least one operating button for adjusting a rotational speed of the electric motor so that the handheld power tool switches between the first operating mode, the second operating mode, and the third operating mode.

10. The handheld power tool according to claim 7, wherein the mode switching device comprises a Hall sensor disposed in the housing.

11. The handheld power tool according to claim 1, wherein the handheld power tool operating in the first operating mode is usable with a cleaning brush; the handheld power tool operating in the second operating mode is usable with a polishing disc; and the handheld power tool operating in the third operating mode is usable with a sanding disc.

12. A polisher, comprising:
a housing;
an electric motor comprising a motor shaft and disposed in the housing;
an output shaft rotatably disposed on the housing; and
a transmission assembly comprising a planet gear assembly, an input end of the planet gear assembly is connected to the motor shaft, and an output end of the planet gear assembly is connected to the output shaft;
wherein the polisher has a cleaning mode, a polishing mode, and a sanding mode; when the polisher is in the cleaning mode, a rotational speed of the output shaft is less than or equal to a first rotational speed; when the polisher is in the sanding mode, the rotational speed of the output shaft is greater than or equal to a second rotational speed; when the polisher is in the polishing mode, the rotational speed of the output shaft is greater than the first rotational speed and less than the second rotational speed.

13. The polisher according to claim 12, further comprising a mode switching device configured to be operated by a user to drive the polisher to switch between at least the cleaning mode, the polishing mode, and the sanding mode.

14. The polisher according to claim 13, comprising a battery coupling portion for mounting a battery pack, wherein the polisher is capable of standing on a placement plane P through a bottom surface of the battery pack, an angle between an axis A of the output shaft and the placement plane P is a first angle α, and the first angle α is greater than or equal to 0° and less than or equal to 20°.

15. The polisher according to claim 14, wherein the housing comprises a grip, the grip is disposed between the electric motor and the battery coupling portion, an angle between an extension direction of the grip and the axis A of the output shaft is a second angle β, and the second angle β is greater than or equal to 50° and less than or equal to 90°.

16. The polisher according to claim 12, wherein the planet gear assembly comprises only one stage of planetary gearset, and a gear ratio of the planet gear assembly is greater than 1 and less than 5.

17. The polisher according to claim 12, wherein the planet gear assembly comprises only two stages of planetary gearsets, and a gear ratio of the planet gear assembly is greater than 1 and less than 15.

18. The polisher according to claim 13, wherein the mode switching device switches a gear of the polisher by transmitting an electrical signal.

19. The polisher according to claim 18, wherein the mode switching device comprises a Hall sensor disposed in the housing.

20. The polisher according to claim 12, further comprising a mode switching device comprising at least one operating button for adjusting a rotational speed of the electric motor so that the polisher switches between the cleaning mode, the polishing mode, and the sanding mode.
